(19) United States
(12) Patent Application Publication
(10) Pub. No.: US 2024/0375071 A1
(43) Pub. Date: Nov. 14, 2024

(54) System and Method for Forming Uniform Particles from a Substrate of Compressed Powdered Material

(71) Applicant: Edward J. Roland, Trenton, NJ (US)

(72) Inventor: Edward J. Roland, Trenton, NJ (US)

(21) Appl. No.: 18/658,914

(22) Filed: May 8, 2024

Related U.S. Application Data
(60) Provisional application No. 63/465,131, filed on May 9, 2023.

(51) Int. Cl. B01J 2/22

(52) U.S. Cl. CPC B01J 2/22

(57) ABSTRACT

A system and method for fragmenting a compressed substrate of powdered materials into particles of a generally uniform size. The compressed substrate is stressed by advancing the compressed substrate between a first curved surface and a first compliant surface. The overhung loads created by the first curved surface and the first compliant surface generate bending stresses in the substrate that fractures the compressed substrate into a plurality of parallel segments. The parallel segments are again stressed by being advanced between a subsequent curved surface and a compliant surface. The bending stresses created by the second curved and the compliant surface fractures the parallel segments into a plurality of particles of nearly uniform size.

### RELATED APPLICATIONS

This application claims priority rights of the U.S. Provisional Patent Application No. 63/465,131 filed May 9, 2023.

### BACKGROUND OF THE INVENTION

### 1. Field of the Invention

In general, the present invention relates to industrial processing machines that are used to form particles from compressed substrates or ribbons of powdered material. More particularly, the present invention relates to systems that can form particles from a compressed substrate with a narrow particles size distribution.

### 2. Description of the Prior Art

In many industries, dry granulated materials are utilized in the production of products. For example, in the pharmaceutical industry, dry compounds are often mixed and granulated before being formed into pills and tablets. Similarly, in the manufacture of batteries, dry mixtures are granulated for use in the formation of cathode pellets. Regardless of the eventual use of the granulated material, the formation of the granulated material is typically made by mixing the required materials together in powdered form. The dry mix is then compressed into a substrate or ribbon. The compressed substrate is then subsequently granulated to produce particles for use in production. If the size of the granulated particles is important in the production process, the granulated particles are typically mechanically filtered to remove any particle that is too large or too small for use in production. This produces waste. The waste particles that are too large or too small must be disposed of, or reworked, therein complicating the production procedure and degrading the material.

If the granulation process utilized on a compressed substrate involves cutting or grinding, the impact of the compressed substrate with hard surface milling elements inevitably creates daughter particles. That is, the traditional hard surface milling processes create very fine particles that are too small to maintain the desired material properties especially good flow ability. Furthermore, fine particles do not fill a fix volume with as great of weight consistency as do larger granules. This property of granules is an essential characteristic required from materials processed on a table press where weight of the tablet is determined by the amount of material that fill a fixed volume formed by positioning a punch in a die.

In U.S. Pat. No. 3,890,080 to Cotts, a processing machine is disclosed that converts a compressed powered material to particles of a uniform size. This is accomplished by individually forming the particles between the teeth of turning helical shafts. As such, only a small volume of particles can be made using any one processing machine. Accordingly, many processing machines have to be utilized at the same time to produce any substantial volume of particles. This creates a bottleneck in production and requires a large investment in processing machinery.

A need therefore exists for an improved processing machine for making uniform sized particles, wherein the machine produces little waste and a single machine embodies a high processing rate. This need is met by the present invention as described and claimed below.

### SUMMARY OF THE INVENTION

The present invention is a system and method for fragmenting a compressed substrate of powdered materials into particles of a generally uniform size. The compressed substrate is stressed by advancing the compressed substrate between a first curved surface and a first compliant surface. The displacement of the compressed material created by the first curved surface and the first compliant surface fractures the compressed substrate fractures into a plurality of parallel segments.

The plurality of parallel segments are again stressed by being advanced between a subsequent curved surface and a compliant surface. The displacement of the compressed material created by the subsequent curved surface and the compliant surface fractures the parallel segments into the plurality of particles. Since the compressed substrate is not milled or fractured by forceful contact with a hard milling elements and surfaces, the production of undersized fine particles is minimized and the final fractured particles are of nearly uniform size. The lack of fines improves the material flow and fill properties.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an overview of the present invention system and method;

FIG. 2 is a fragmented view of an exemplary embodiment of the first fragmentation device for use in the present invention system;

FIG. 3 is an enlarged view of a section of the first fragmentation device of FIG. 2 illustrating how fractures are formed in the compressed substrate;

FIG. 4 is an enlarged view of a section of the compressed substrate showing the forces incurred by the compressed substrate between rollers;

FIG. 5 is an alternate embodiment for the first fragmentation device that utilizes a roller and a belt to fragment the compressed substrate;

FIG. 6 is an alternate embodiment for the first fragmentation device that utilizes a first belt and a second belt to fragment the compressed substrate;

FIG. 7 is an exemplary embodiment of the second fragmentation device that utilizes a small roller and a large roller to fragment the substrate strips;

FIG. 8 is an alternate embodiment that combines the first fragmentation device and the second fragmentation device into a first alternate assembly;

FIG. 9 is an alternate embodiment that combines the first fragmentation device and the second fragmentation device into a second alternate assembly;

FIG. 10 is an alternate embodiment that combines the first fragmentation device and the second fragmentation device into a third alternate assembly; and

FIG. 11 is an alternative embodiment that combines three fragmentation devices into one assembly.

### DETAILED DESCRIPTION OF THE DRAWINGS

Although the present invention granulation system and methodology can be embodied in many ways, only a few exemplary embodiments are illustrated. The exemplary embodiments are shown for the purposes of explanation and description. The exemplary embodiments are selected in order to set forth some of the best modes contemplated for the invention. The illustrated embodiments, however, are merely exemplary and should not be considered limitations when interpreting the scope of the appended claims.

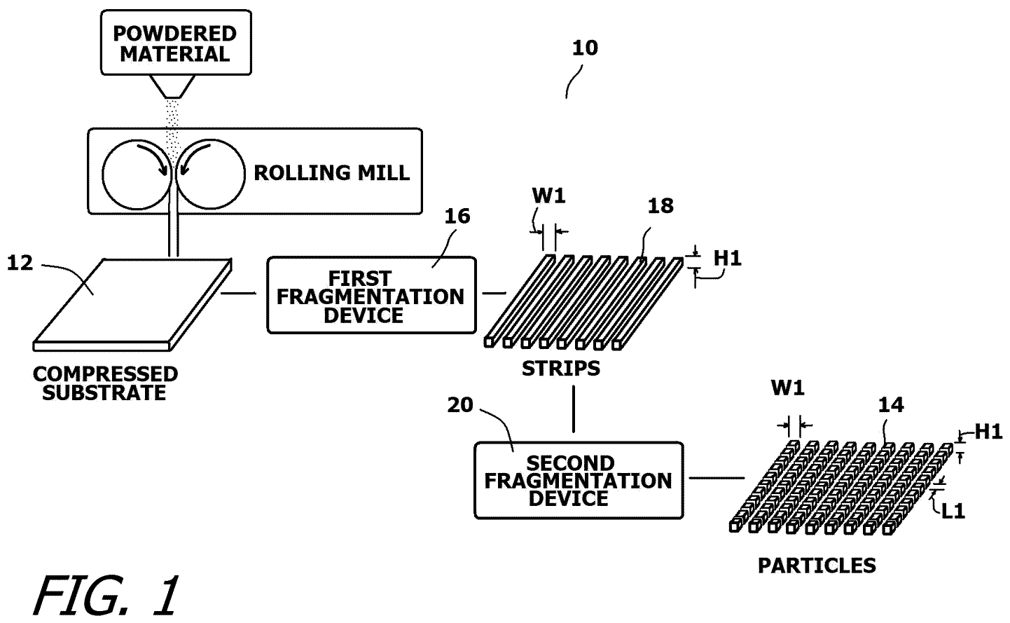

Referring to FIG. 1, an overview of the present invention granulation system and method is shown. The granulation system 10 receives a compressed substrate 12, which is sometimes referred to as a compressed ribbon. The compressed substrate 12 is created by a powder material procession machine that compacts powdered material into the compressed substrate 12. An exemplary powder material processing machine is disclosed in co-pending U.S. patent application Ser. No. 18/658,803, the disclosure of which is herein incorporated to by reference.

The purpose of the granulation system 10 is to convert the compressed substrate 12 into particles 14 that are in the same selected size range while minimizing the amount of material converted into particles outside of the selected size range. The granulation system 10 utilizes a first fragmentation device 16 that breaks the compressed substrate 12 into parallel substrate strips 18. As will be explained, the first fragmentation device 16 breaks the compressed substrate 12 into parallel substrate strips 18 using bending stresses, which produces little to no undersized particles, i.e. little or no fines. The parallel substrate strips 18 have an average width W1 and an average height H1. The parallel substrate strips 18 are then directed into a second fragmentation device 20. As will be explained, the second fragmentation device 20 breaks the parallel substrate strips 18 into particles 14 by also using displacement bending stresses. This produces particles 14 having an average width W1. The average length L1, average height H1 and average width W1 are all maintained within selected maximum and minimum values. If particles 14 of nearly uniform size are desired, the granulation system 10 can be adjusted to match the particle height H1, particle length L1 and particle width W1 to the same size tolerances.

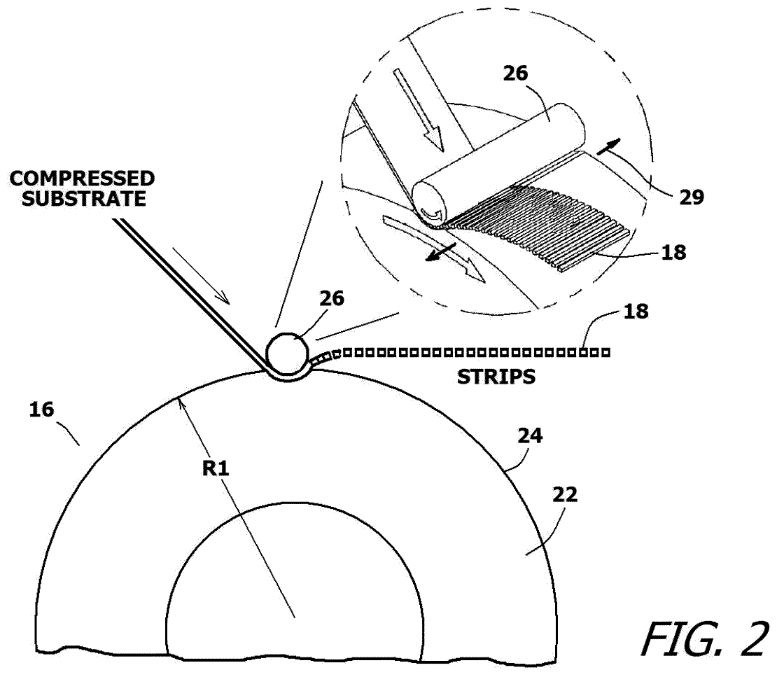

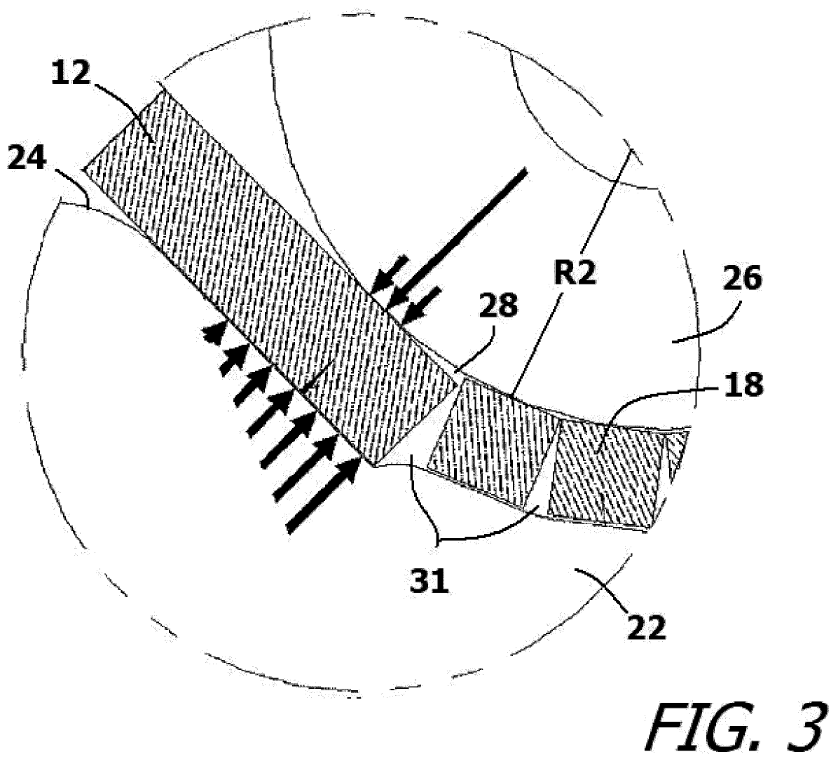

Referring to FIG. 2 in conjunction with FIG. 3, it can be seen that the first fragmentation device 16 is an asymmetrical rolling mill. The first fragmentation device 16 has a large roller 22 made from an elastomeric material with a soft durometer. This supplies the large roller 22 with a compliant exterior surface 24. The large roller 22 has a radius R1. The large roller 22 preferably has a Shore 00 harness on its exterior surface 24 in the extra-soft to medium soft range, i.e. under 80 Shore 00. This enables the exterior surface 24 of the large roller 22 to deform in multiple directions when stressed. During operations of the first fragmentation device 16, the first roller 22 is turned by a motor (not shown). The rotational rate of the first roller 22 can be selectively adjusted.

The first fragmentation device 16 also has a radius surface that is illustrated as small roller 26. The small roller 26 has a radius R2, which is at least equal to or smaller than the radius R1 of the large roller 22 and very often four times or more smaller than the radius R1 of the large roller 22. The small roller 26 is firmer than the large roller 22. In this manner, the small roller 26 will indent the large roller 22 when biased against the large roller 22. A gap space 28 exists between the small roller 26 and the large roller 22. The gap space 28 is smaller than the thickness of the compressed substrate 12 but no larger than the desired height dimension H1 of the particles 14 to be produced.

As the compressed substrate 12 enters the gap space 28 between the small roller 26 and the large roller 22, and comes in contact with the rollers the confined substrate 12 is exposed to increasingly perpendicular contact loads. The compression forces applied by the small roller 26 are transferred to the low durometer material of the large roller 22. Accordingly, the material of the large roller 22 deforms. The exterior surface 24 of the large roller 22 deforms toward the center of the large roller 22. Furthermore, deformation of the large roller 22 causes the exterior surface 24 of the large roller 22 to spread in the directions of the arrows 29.

Referring to FIG. 3 and FIG. 2, it can be seen that since the large roller 22 has a radius R1 that is much larger than the radius R2 of the small roller 26, the compressed substrate 12 contacting the large roller 22 is moved over a longer distance than is the compressed substrate 12 contacting the smaller roller 26 in the same period of time. As such, the compressed substrate 12 contacting the large roller 22 travels passed the center of the contact load from the smaller roller and is now supporting an opposing overhung load from the larger roller. The overhung load generates a bending moment in the substrate that results in relatively high internal tensile and compressive bending stresses.

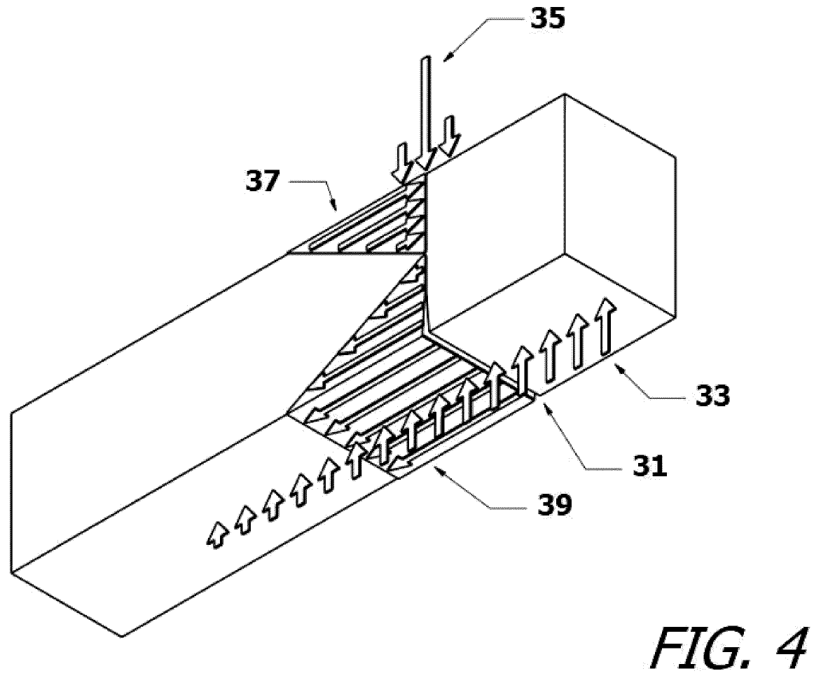

Referring to FIG. 4 in conjunction with FIG. 3, it can be seen that the compressed substrate 12 experienced forces 33 from the larger roller 22 along a long area. Opposing forces 35 from the smaller roller 26 are experienced in a more defined area. This creates both compressive stresses 37 and tensile stresses 39 that concentrate and form the fracture 32.

Being these materials are typically relatively weak in tension, the moment induced bending tensile stresses cause fractures 31 in the compressed substrate 12 as it passes through the gap space 28. The consistent rotation of the large roller 22 and the small roller 26 cause fractures 31 to occur at repeating intervals. The fractures 31 breaks the compressed substrate 12 into repeating parallel strips 18. The width of the substrate strips 18 can be adjusted in a range by controlling the rotational speed of the large roller 22 and the size of the gap space 28. The width of the substrate strips 18 is set to the desired width W1 of the particles 14.

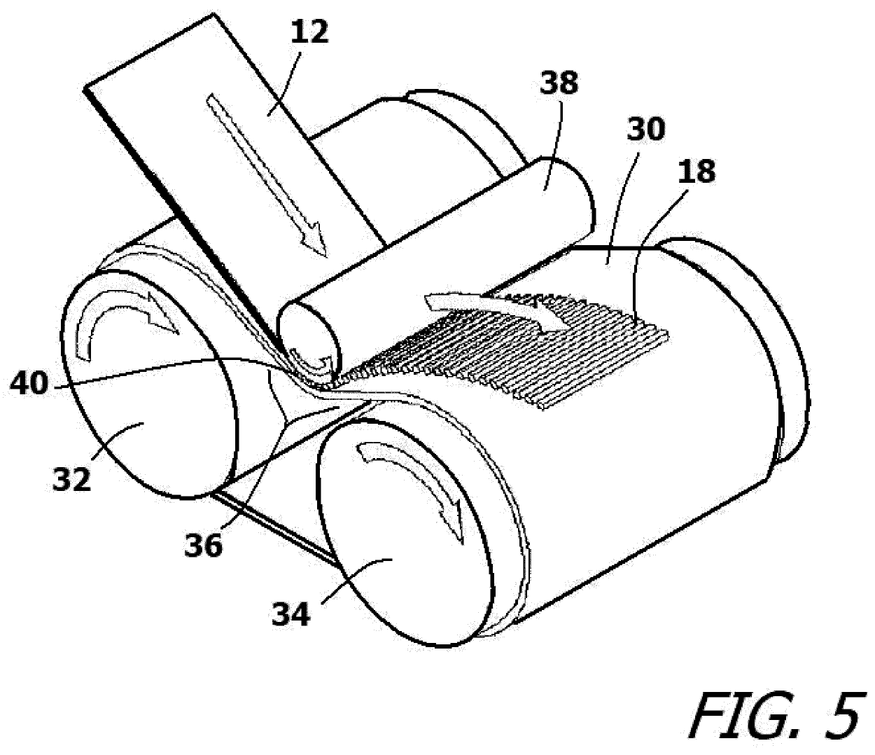

The use of a large roller 22 and a small roller 26 in the first fracturing device 16 is only one possible way to create the substrate strips 18. The same dynamics can be applied to the compressed substrate 12 using curved surfaces other than rollers and compliant curved surfaces other than soft rollers. Referring to FIG. 5, one such alternate embodiment is shown. In this embodiment, an elastic belt 30 is supplied as the curved compliant surface. The elastic belt 30 is stretched between two drums 32, 34. The belt 30 passes through a central section 36 where the belt 30 is suspended between the drums 32, 34. In the central section 36, the elastic belt 30 can be readily depressed and curved. As the elastic belt 30 is depressed downwardly, the elastic belt 30 can also elongate laterally.

A curved surface, again configured as a small roller 38, is positioned above the central section 36 of the elastic belt 30. A gap space 40 exists between the small roller 38 and the elastic belt 30. The compressed substrate 12 is fed into the gap space 40. The compressed substrate 12 contacting the elastic belt 30 moves over a longer distance than does the compressed substrate 12 contacting the small roller 38 in the gap space 40. As such, the compressed substrate 12 contacting the elastic belt 30 is moving slower than the compressed substrate 12 contacting the small roller 38. Due to the disparity in movement, internal bending stresses are created in the compressed substrate 12. The bending stresses combine with the lateral spreading forces applied by the deforming elastic belt 30 to cause fractures in the compressed substrate 12 as it passes through the gap space 40. The consistent rotation of the elastic belt 30 and the small roller 38 cause the fracturing of the compressed substrate 12 to occur at repeating intervals. The fracturing breaks the compressed substrate 12 into repeating rows of substrate strips 18.

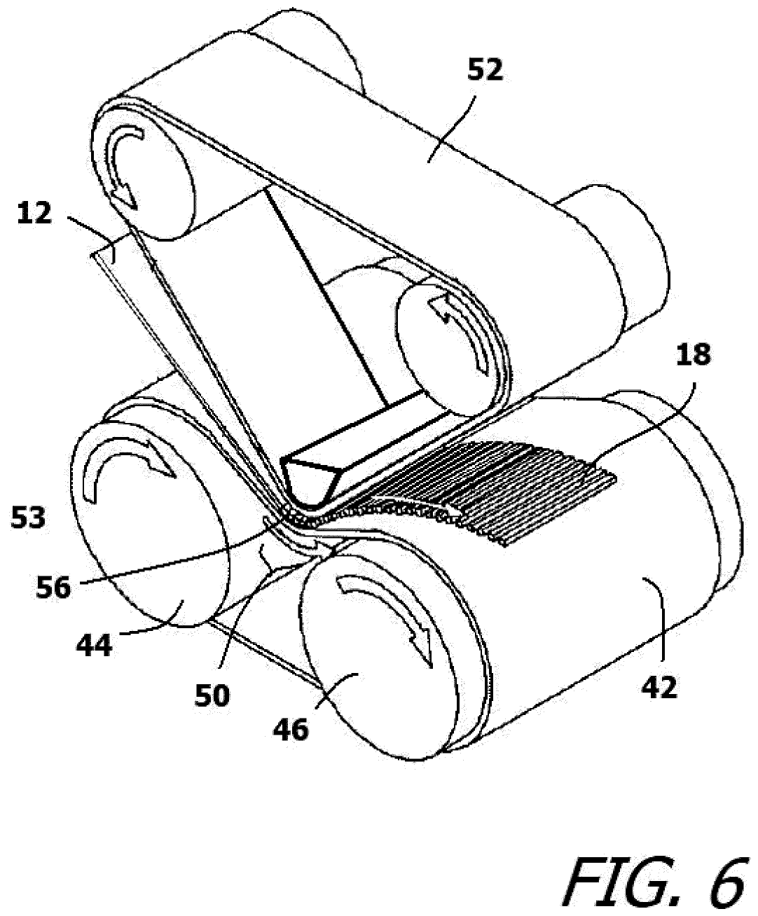

The small roller 38 can also be replaced. Referring to FIG. 6, an alternate embodiment is shown that uses a belt system that bends over a curved surface. In this embodiment, a first elastic belt 42 is stretched between two drums 44, 46. The first elastic belt 42 passes through a central section 50 where the first elastic belt 42 is suspended between the drums 44, 46. The central section 50 of the first elastic belt 42 can be readily depressed. As the first elastic belt 42 is depressed downwardly, the first elastic belt 42 curves as it stretches and elongates.

A second elastic belt 52 is positioned above the central section 50 of the first elastic belt 42. The second elastic belt 52 passes around a curved surface 53, therein providing the second elastic belt 52 with a bend 54 that have a small radius of curvature. A gap space 56 exists between a bend 54 on the second elastic belt 52 and the central section 50 of the first elastic belt 42. The compressed substrate 12 is fed into the gap space 56. The compressed substrate 12 contacting the first elastic belt 42 moves over a longer distance than does the material contacting the second elastic belt 52 in the gap space 56. As such, the compressed substrate 12 contacting the first elastic belt 42 is moving slower than the compressed material 12 contacting the second elastic belt 52. Due to the disparity in movement, internal bending stresses are created in the compressed substrate 12. The bending stresses combine with the lateral spreading forces applied by the deforming belts 42, 52 to cause fractures in the compressed substrate 12 as it passes through the gap space 56. The consistent rotation of the belts 42, 52 causes the fracturing of the compressed substrate 12 to occur at repeating intervals. The fracturing breaks the compressed substrate 12 into repeating rows of substrate strips 18.

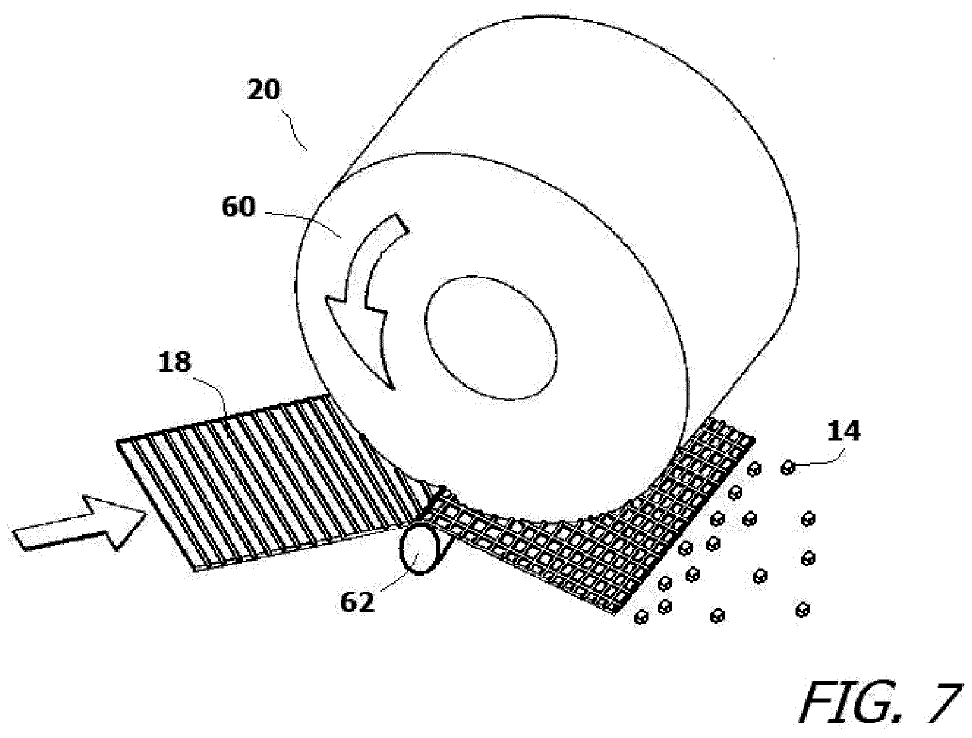

Returning to FIG. 1, it will be understood that using any of the above described techniques, the compressed substrate 12 is fractured into parallel substrate strips 18. The substrate strips 18 are supported and are fed into a second fracturing device 20 in an offset orientation. The second fracturing device 20 then fractures each of the substrate strips 18 into particles 14 of generally the same size. Referring to FIG. 7, an exemplary embodiment of the second fracturing device 20 is shown. As can be seen, the second fracturing device 20 is the same as the first fracturing device 16 shown in FIG. 2 and FIG. 3, but is shown in an inverted orientation. Accordingly, the second fracturing device 20 has a large roller 60 and a smaller curved surface 62. The substrate strips 18 are fed into the second fracturing device 20 at an offset angle of between forty-five degrees and ninety degrees from the initial orientation of the substrate strips 18. The substrate strips 18 are therefore fractured along their lengths into particles 14 of nearly uniform size without producing any significant amounts of fine particle dust.

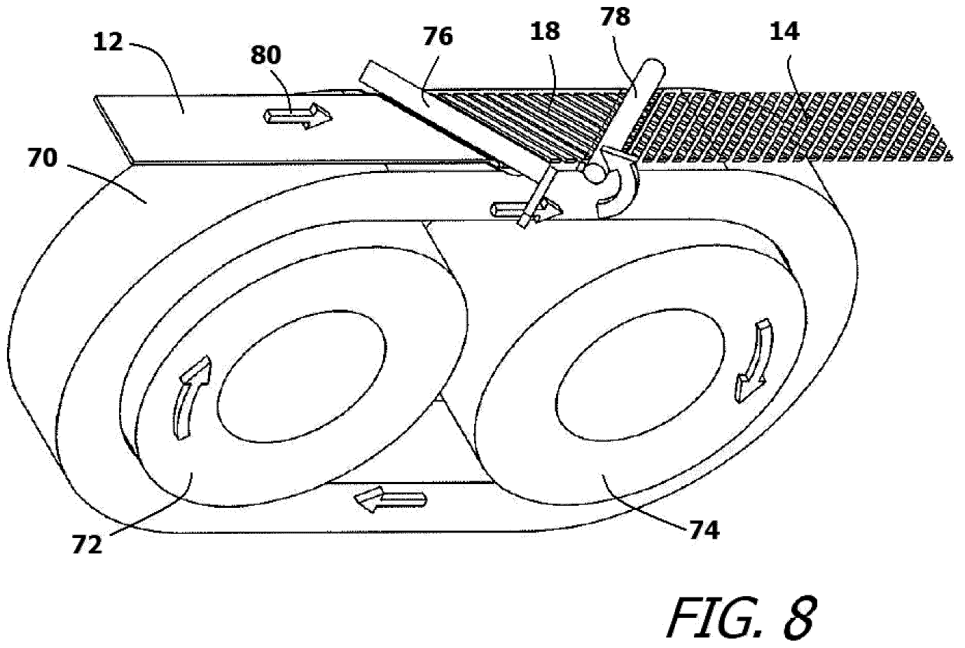

It will be understood that since the fracturing process utilized by the first fracturing device and the second fracturing device are the same, the first fracturing device and the second fracturing device can be embodied in a single machine that shares components. Referring to FIG. 8, one such alternate embodiment is shown. In FIG. 8, the compliant surface is a flexible belt 70 that rotates about a first drum 72 and a second drum 74. Two curved surfaces 76, 78 are provided that press against the flexible belt 70 at different locations. The first curved 76 serves as the first fracturing device and the second curved 78 serves as the second fracturing device.

The flexible belt 70 travels in a first direction, as indicated by arrow 79. The first curved surface 76 is offset from the first direction by an angle of up to 45 degrees. The first curved surface 76 biases the compressed substrate 12 against the flexible belt 70. For the reasons previously explained, the first curved surface 76 and the flexible belt 70 create displacement stresses in the compressed substrate 12 that fractures the compressed substrate 12 into substrate strips 18. Due to the angle of the first curved surface 76, the substrate strips 18 are created at the same angle as the first curved surface 76, which is offset from the travel direction of the flexible belt 70.

The second curved surface 78 is offset from the belt travel direction by an angle up to 45 degrees and is offset from the first curved surface 76 by up to 90 degrees. The second curved surface 78 biases the compressed substrate 12 against the flexible belt 70. For the reasons previously explained, the second curved surface 78 and the flexible belt 70 create displacement stresses in the substrate strips 18 that fracture the substrate strips 18 into particles 14.

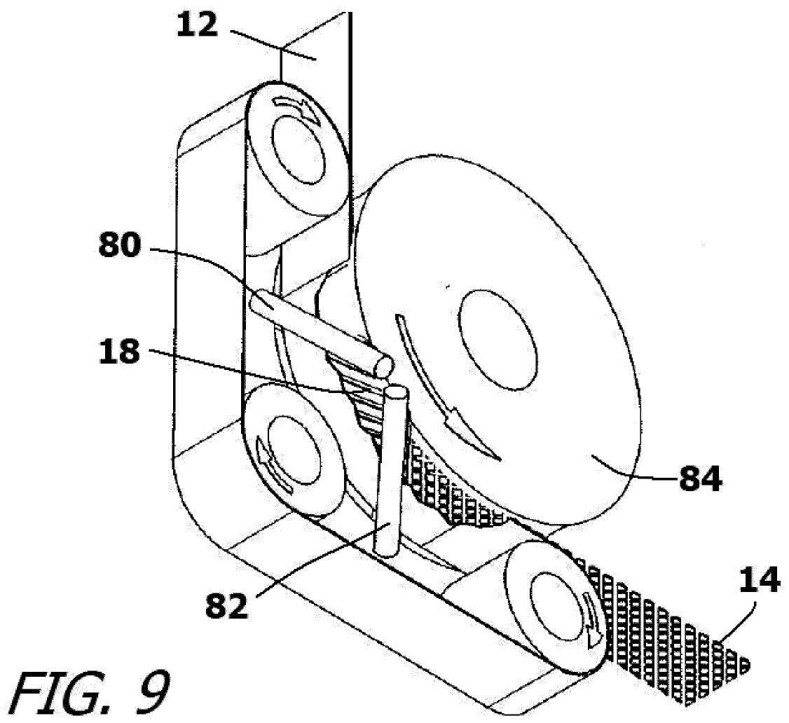

Referring to FIG. 9, a variation of the embodiment of FIG. 8 is shown. As such, like parts are identified with the same reference numbers to avoid confusion. In the embodiment of FIG. 9, two curved surfaces 76, 78 are provided that press against the flexible belt 70 at different locations. The first curved 76 serves as the first fracturing device and the second curved 78 serves as the second fracturing device. The first curved surface 76 is offset from the first direction by an angle of up to 45 degrees.

A second belt 75 is provided that passes under the two curved surfaces 76, 78. The compressed substrate is interposed between the first flexible belt 70 and the second belt 75. The first curved surface 76 biases the second belt 75 and the compressed substrate 12 against the first flexible belt 70. For the reasons previously explained, the action creates displacement stresses in the compressed substrate 12 that fractures the compressed substrate 12 into substrate strips 18. Due to the angle of the first curved surface 76, the substrate strips 18 are created at the same angle as the first curved surface 76, which is offset from the travel direction of both the first flexible belt 70 and the second belt 75.

The second curved surface 78 is offset from the belt travel direction by an angle up to 45 degrees and is offset from the first curved surface 76 by up to 90 degrees. The second curved surface 78 biases the compressed substrate 12 against the flexible belt 70. For the reasons previously explained, the second curved surface 78 and the flexible belt 70 create displacement stresses in the substrate strips 18 that fracture the substrate strips 18 into particles 14.

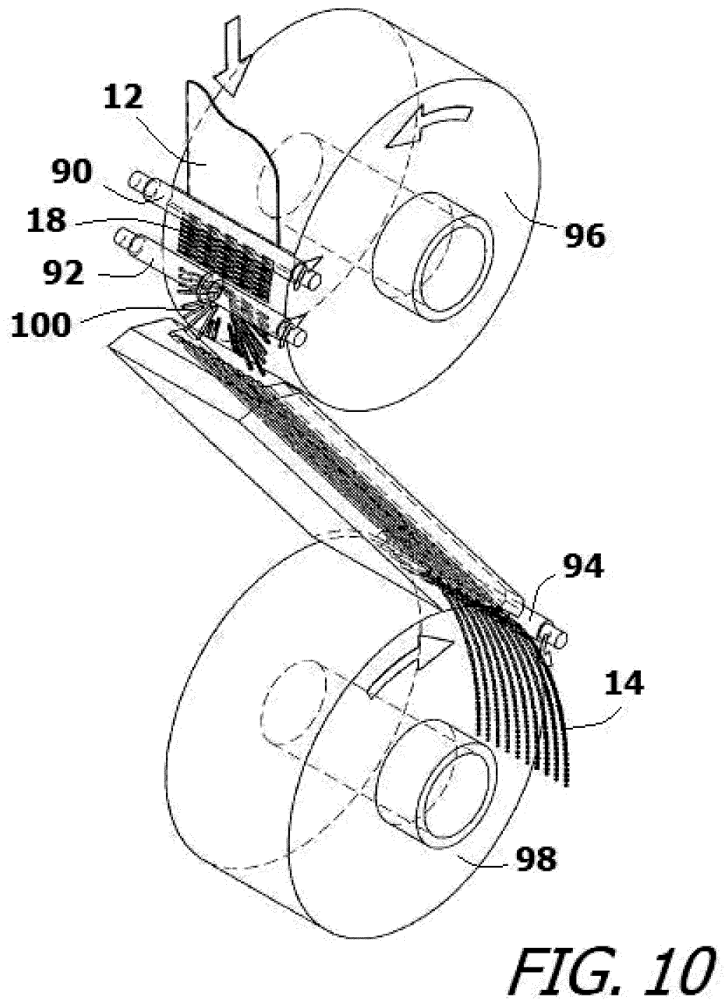

Referring to FIG. 10, it can be seen that a first small curved surface 80 and a second small curved surface 82 can also engage different areas of a common large roller 84. The first small curved surface 80 is offset from the rotational plane of the large roller 84 by an angle of up to 45 degrees. The first small curved surface 80 biases the compressed substrate 12 against the large roller 84. For the reasons previously explained, the first small curved surface 80 and the large roller 84 create displacement stresses in the compressed substrate 12 that fracture the compressed substrate 12 into substrate strips 18. Due to the angle of the first curved surface 80, the substrate strips 18 are created at the same angle as the first curved surface 80, which is offset from the travel direction of the large roller 84.

The second curved surface 82 is offset from the travel direction of the large roller 84 by an angle of up to 45 degrees and is offset from the first curved surface 80 by up to 90 degrees. The second radiuses surface 82 biases the compressed substrate 12 against the large roller 84. For the reasons previously explained, the second curved surface 82 and the large roller 84 create displacement stresses in the substrate strips 18 that fractures the substrate strips 18 into particles 14.

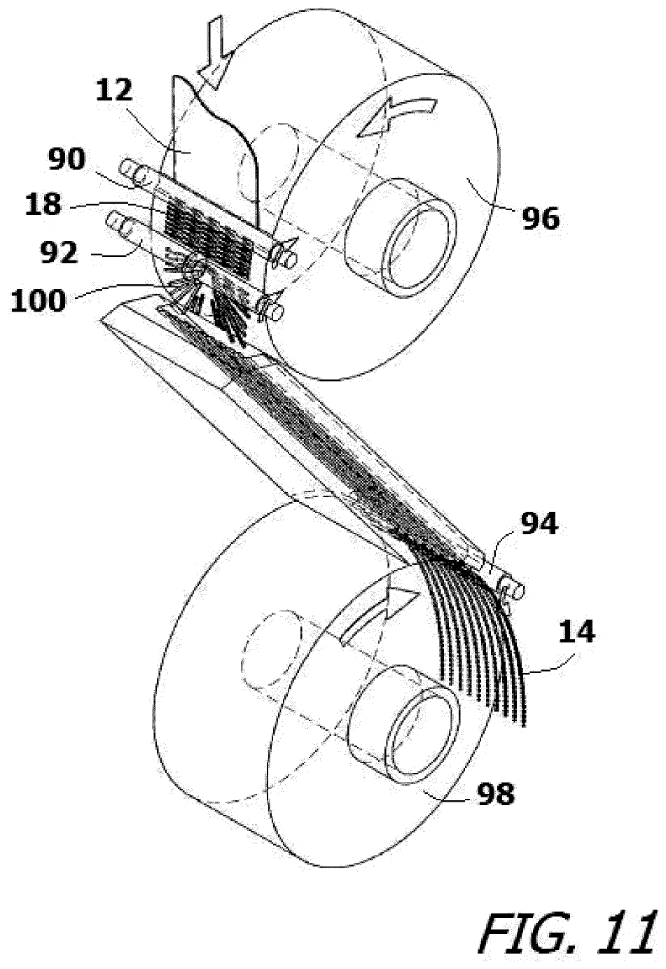

In all earlier embodiments, two fractured devices are used. The first fracturing device fractures the compressed substrate into substrate strips and the second fracturing device fractures the substrate strips into particles. However, more than two fracturing devices can be used. Referring to FIG. 11, an embodiment is shown that utilizes more than two fracturing devices. In FIG. 11, three small rollers 90, 92, 94 are used with two large rollers 96, 98. The first small roller 90 fractures the compressed substrate 12 against the first large roller 96 and creates substrate strips 18. The second small roller 92 cuts the substrate strips 18 to create and reorient the cut segments 100 of the compressed substrate 12. The third small roller 96 biases the cut segments 100 against the second large roller 98. For the reasons previously explained, the third small roller 94 and the second large roller 98 create displacement stresses in the cut segments 100 that fracture the cut segments into particles 14.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A method for breaking a substrate of compressed powder material into a plurality of particles, comprising:
stressing said substrate by advancing said substrate between a first curved surface and a first compliant surface to fracture said substrate into a plurality of segments; and
stressing said plurality of segments by advancing said plurality of segments between a subsequent curved surface and a second compliant surface to fracture said plurality of segments into said plurality of particles.

2. The method according to claim 1, wherein said first compliant surface is an exterior surface of a roller.

3. The method according to claim 2, wherein said first curved surface has a first diameter and said roller has a second diameter that is equal to or greater than said first diameter.

4. The method according to claim 2, wherein said first curved surface has a first durometer and said first compliant surface has a second durometer that is lower than said first durometer, therein enabling said first curved surface to elastically deform said first compliant surface as said substrate passes between said first curved surface and said first compliant surface.

5. The method according to claim 1, wherein said plurality of segments are parallel strips of said substrate that are oriented in a first direction.

6. The method according to claim 5, wherein said plurality of segments is reoriented into a second direction before advancing between said subsequent curved surface and said second compliant surface.

7. The method according to claim 1, wherein said second compliant surface is an exterior surface of a secondary roller.

8. The method according to claim 7, wherein said subsequent radiuses surface has a first diameter and said secondary roller has a second diameter that is at least four time greater than said first diameter.

9. The method according to claim 2, wherein said subsequent curved surface has a first durometer and said second compliant surface has a second durometer that is lower than said first durometer, therein enabling said subsequent radiuses surface to deform said second compliant surface as said substrate passes between said subsequent curved surface and said second compliant surface.

10. The method according to claim 1, wherein said first compliant surface and said second compliant surface are different areas on an exterior surface of a common secondary roller.

11. The method according to claim 1, wherein said first compliant surface is a belt that supports said substrate and moves said substrate under said first curved surface.

12. A method for breaking a substrate of compressed powder material into a plurality of particles, comprising:
stressing said substrate by advancing said substrate between a first roller and a compliant surface to fracture said substrate into a plurality of segments;
stressing said plurality of segments by advancing said plurality of segments between a second roller and a second compliant surface to fracture said substrate into said plurality of particles.

13. The method according to claim 12, wherein said first roller has a first radius of curvature.

14. The method according to claim 13, wherein said first compliant surface is selected from a group comprising an exterior surface of a secondary roller and an exterior surface of a rotating belt.

15. The method according to claim 12, wherein said first roller has a first durometer and said first compliant surface has a second durometer that is lower than said first durometer, therein enabling said first roller to deform said first compliant surface as said substrate passes between said first roller and said first compliant surface.

16. The method according to claim 12, wherein said plurality of segments are parallel strips of said substrate that are oriented in a first direction.

17. The method according to claim 16, wherein said plurality of segments are reoriented into a second direction before advancing between said second roller and said second compliant surface.

18. The method according to claim 12, wherein said first compliant surface and said second compliant surface are different areas on an exterior surface of a common secondary roller.

19. The method according to claim 12, wherein said first compliant surface and said second compliant surface are different areas on an exterior surface of a common flexible belt.
